(19) United States
(12) Patent Application Publication
(10) Pub. No.: US 2012/0329010 A1
(43) Pub. Date: Dec. 27, 2012

(54) WINGED IMPLANT

(76) Inventors: Zvi Laster, Poriya Elite (IL); Ole T. Jensen, Engelwood, CO (US); Meir Mamraev, Rishon Lazion (IL)

(21) Appl. No.: 13/603,461

(22) Filed: Sep. 5, 2012

Related U.S. Application Data
(63) Continuation-in-part of application No. 12/926,286, filed on Nov. 8, 2010.
(60) Provisional application No. 61/398,331, filed on Jun. 24, 2010.
(60) Provisional application No. 61/283,976, filed on Dec. 11, 2009.

(51) Int. Cl. A61C 8/00

(52) U.S. Cl. 433/174

(57) ABSTRACT

A winged implant is provided with at least one wing member extending generally radially outwardly away from the implant body adjacent a distal end thereof. The external periphery of the implant body is provided with external threads for cutting into, and embedding the implant body within, a substrate, and the diametrical extent of the wing member is substantially larger than the diametrical extents of the implant body and the external threads so as to provide enhanced stabilization for the implant body when implanted within the substrate.

### CROSS-REFERENCE TO RELATED APPLICATIONS

This patent application claims priority to U.S. Provisional Patent Application Ser. No. 61/398,331, filed Jun. 24, 2010, entitled “Winged Implant”, itself claiming priority to U.S. Provisional Patent Application Ser. No. 61/283,976, filed Dec. 11, 2009, entitled “Winged Implant”. This patent application is also a Continuation-In-Part (CIP) of U.S. Patent Application Ser. No. 12/926,286, entitled “Winged Implant”, and filed on Nov. 8, 2010, the priority benefits of which are also claimed.

### FIELD OF THE INVENTION

The present invention relates to a winged implant, which is adapted to be inserted into and/or applied to bone and/or osseous tissue during a dental implant procedure, wherein, in addition to external threads disposed upon the external periphery thereof for threaded insertion and engagement within the bone or osseous tissue, the winged implant also comprises at least one wing member or element, having a diametrical extent which is substantially larger than the diametrical extent of the external threads, as determined at the crest portions thereof, for stabilizing the implant within the bone or osseous tissue.

### BACKGROUND OF THE INVENTION

Generally, implants are adapted to be used during an implant procedure. During implant procedures, a crater may be formed, which may initially be filled with congealing blood and bone fragments. The crater may generally have a frusto-conical shape.

As may be customary, implant procedures may take place immediately or relatively soon after the crater is formed. Thus, the implant may be only partially lodged within solid bone, with a considerable portion thereof extending substantially unsupported outwardly from the crater so that, relative to the crater, the implant comprises a cantilevered structure. Such a mode of operation may compromise the implant stability, as is well known in the art, and as may be measured as an ISQ or Implant Stability Quotient. Improved implant stability may enhance osseointegration. Such a requirement for stability is greatly desired, particularly if immediate loading is performed subsequent to the implant procedure.

In the French Patent FR 2645011 to Florian, entitled “Bone Implant Eyebolt Which Is Intended On The One Hand To Form An Artificial Tooth Root And On The Other Hand To Reduce Bone Fractures, And Which Can Be Used In Ear, Nose And Throat Treatment”, there is disclosed, inter alia, a device for fixing an implant eyebolt to a bone in order to hold a tooth prosthesis to the bone and to reduce bone fractures. It consists of a cylinder 1 made of pure titanium for medical use, it is provided in its upper part with a flat-head screw 4 having a slot 5 so that it can be maneuvered by means of a screwdriver, and is provided within its lower part with two cylindrical pins 2 for locking the implant to the bone. Prior to the positioning of this implant eye-bolt, a bore is drilled with a bone-drill bur having the dimension of the eyebolt with a stop, a grinding bur with a stop is used for the lateral and circular grinding or burring of the lower part 9, and a bone fissure bur with a stop for burring two small lateral walls. The device makes it possible to hold in position, by means of implant 12, a tooth prosthesis, and to reduce bone fractures by locking the implant eyebolt to the bone, the device further permitting osseointegration in the parts left empty by the burring and grinding.

In U.S. Pat. No. 4,722,687 to Scortecci, entitled “Dental Implant For The Securement Of Fixed Dental Prostheses”, there is disclosed, among other things, a dental implant that serves as its own cutting tool for forming a T-shaped slot within a human tooth so as to receive the implant, and comprises a flat circular wheel having cutting teeth upon its periphery. An elongated shaft is secured coaxially to the wheel and has milling surfaces thereon that extend from the wheel a distance which is several times greater than the thickness of the wheel and several times greater than the diameter of the milling surfaces. The diameter of the wheel is several times greater than the diameter of the milling surfaces. A portion of the shaft extending beyond the milling surfaces in a direction away from the wheel permits the releasable securement of the implant to a dental drill.

In United States Patent US2006110707 to Perez et al., entitled “Dental Implant”, there is disclosed, inter alia, a rounded, mill-like member having an external diameter d1 centered upon the implant's main axis and co-axial with a secondary, horizontal axis located at a right angle with the implant's main axis, wherein the mill-like member is characterized by a jagged milling surface at the distal end thereof facing the jawbone. An abutment is located at the proximal end and extends from the mill-like member towards the oral cavity, and the drill-like member is adapted to penetrate perpendicularly to a predetermined depth so as to accommodate an intrabone portion of the jawbone, while the mill-like member is fixated in a diameter d1 to a supra-bone portion of the jawbone. Surprisingly, the dental implant according to this patented invention is endowed with an improved durability to the forces generated within the oral activity, such as, for example, mastication or the like, and is resistant against perpendicular forces as well as lateral forces, yet the insertion thereof into the patient's jawbone is performed in a single-step operation and does not require cutting a second incision or more in the patient's mouth, thus combining the advantages of vertical penetrating implants, such as, for example, short treatment and healing process times and less risk of infection, with the strength and durability of laterally inserted implants, achieved as a result of the efficient fastening mechanism provided for securing the implant in place to the bone.

Lastly, in German Patent DE4142584 to Lang, entitled “Dental Implant For Retaining False Tooth—Has Sickle Shaped Ribs With Sharp Edges Arranged In Helix”, there is disclosed a dental implant for retaining a false tooth which has a cylindrical upper part (2) and a tapered lower part (1). The lower part has a number of sickle shaped ribs (3) which project radially outwardly. The ribs are positioned so that they lie upon a helix which winds around the tapered lower part. When the implant is inserted into the alveole of the patient's jaw, these ribs cut into the walls of the alveole and hold the implant in place. The upper part of the implant has a tapped hole to receive the screwed shank of the false tooth. The implant for retaining the false tooth need not be inserted to the full depth of the alveole.

It would be desirable to have a wing implant that, when attempting unscrewing, will tend to resist it. Furthermore, it would be desirable to enhance the implant stability, as may be measured as an ISQ. Therefore, there currently exists a need in the industry for an implant and an associated method of implanting the implant that may tend to resist any application of an unscrewing torque applied thereto, and which may likewise tend to resist bending moments and forces applied thereto. This may be attained in accordance with the principles and teachings of the present invention.

### SUMMARY OF THE INVENTION

In the following disclosure, aspects thereof are described and illustrated in conjunction with systems and methods that are meant to be exemplary and illustrative and not limiting in scope.

The present invention is broadly concerned with an implant that is designed for implantation, more specifically within human and/or animal tissues, and to a method of implanting the associated implant. With respect to the implant per se, the implant comprises an implant body, which is generally shaped as a self-tapping screw, and which is capable of tapping into bone tissues during an implant procedure, and is also capable of resisting, or tending to resist, sideways forces, after the implant has set, that is, after osseointegration. The implant body has external threads formed around the external periphery thereof for cutting or tapping into the bone or osseous tissue, and furthermore comprises at least one wing member which extends radially outwardly so as to generally extend transversely to, and away from, the longitudinal axis of the implant body.

With respect to the associated method of implanting the implant, the same comprises providing at least one wing member extending radially outwardly from the implant body so as to extend transversely to, and away from, the longitudinal axis of the implant body. In this manner, when applying sideways forces to the implant, the at least one wing may contact or engage a sidewall of the cavity formed before and/or during the implant procedure, and thereby contribute to the stabilization of the implant implanted within the cavity.

According to one aspect of the present invention, the implant is provided with an implant body comprising an apical end, a distal end, and a longitudinal axis L extending through the implant body from the apical end to the distal end, and at least one wing member extending generally transversely to the longitudinal axis L and away from the implant body. External threads are disposed around the external periphery of the implant body so as to cut into bone and osseous tissue as the implant body is rotationally inserted into the patient's jaw.

The at least one wing member extends generally transversely to the longitudinal axis L from a wing root, where the at least one wing member joins the implant body, to a cantilevered wing end, and may comprise a span arch which extends from a tangentially forwardly disposed leading end to a tangentially rearwardly disposed trailing end, the span arch having a circumferential or peripheral angular extent that is considerably smaller than the angular extent of the circumference of the distal end of the implant body. The at least one wing member is preferably disposed upon the anchor or implant body adjacent the distal end thereof.

The at least one wing member may have any desirable wing cross-section, such as, for example, that of a rhombus, a circle, a teardrop, a trigon, an ellipse, a triangle, or a square. In addition, the at least one wing member may further comprise a wing support which may extend from a radially outward end of the at least one wing member back toward the implant body so as to terminate at or upon the distal end of the implant body.

The wing implant body is provided with a depression or socket defined within its distal end for the reception of a suitable rotary tool. Still further, the wing implant body is formed with a threaded receptacle so as to receive a threaded screw or bolt.

A longitudinal cross-section through the distal end of the winged implant discloses the fact that the wing cross-section may be that of a trapezoid having a wide wing root and tapering away towards the wing tip.

The at least one wing member preferably comprises a single annular or completely circumferential wing member that follows a spiral path along the external periphery of the distal end of the wing implant so as to effectively comprise an uppermost continuation of the external helical threads disposed upon the external periphery of the implant body. Furthermore, the at least one wing comprises a narrowing of the wing tip so as to facilitate the threading-in of the winged implant.

Still further, if the wing member comprises only a peripheral section having an angular span arch A, the circumferential angular extent of the span arch A is only a fractional portion of, and substantially smaller than, the entire circumferential angular extent C of an otherwise completely circumferential wing member.

Optionally, the wing sections may be located at different axial positions relative to the longitudinal axis L, and may be staggered either circumferentially and/or longitudinally about the distal end of the implant body. All of the wing sections may be disposed about a single helix.

According to another aspect of the present invention, during an implant procedure, an exemplary method of enhancing the stability of the implant may be employed, wherein the method comprises providing the implant body with at least one wing extending generally away from the wing implant body adjacent the distal end thereof When the winged implant is implanted, for example, within a crater which may be formed during an implant procedure, the implant body may be supported and stabilized by the at least one wing, thereby enhancing the stability of the winged implant within the crater.

### BRIEF DESCRIPTION OF DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1a is a schematic longitudinal cross-sectional view of a first embodiment of a winged implant, constructed in accordance with the principles and teachings of the present invention, as implanted within a tissue;

FIG. 1b is a schematic longitudinal cross-sectional view of the first embodiment of the winged implant, to be implanted with in a tissue, as shown in FIG. 1a;

FIG. 2 is a side elevational view of the first embodiment of the implant, as illustrated within FIGS. 1 and 2, wherein the wing member has a rhomboid cross-sectional configuration;

FIG. 3 is a side elevational view of a second embodiment of a winged implant wherein the wing member has a circular cross-sectional configuration and the wing member comprises a cylinder;

FIG. 4 is a side elevational view of a third embodiment of a winged implant member wherein the wing member has a circular cross-sectional configuration and the wing member comprises a frusto-conical structure;

FIG. 5 is a side elevational view of a fourth embodiment of a winged implant wherein the wing member has a teardrop-shaped cross-sectional configuration;

FIG. 6 is a side elevational view of a fifth embodiment of a winged implant wherein the wing member has a trigon cross-sectional configuration;

FIG. 7 is a side elevational view of a sixth embodiment of a winged implant wherein the wing member has an ellipsoid cross-sectional configuration;

FIG. 8 is a side elevational view of a seventh embodiment of a winged implant wherein the wing member has a triangular cross-sectional configuration;

FIG. 9 is a side elevational view of an eighth embodiment of a winged implant wherein the wing member has a square-shaped cross-sectional configuration;

FIG. 10 is a partial, downwardly directed perspective view of a winged implant having a modified wing member with respect to the winged implant shown schematically in FIG. 9, wherein the wing member has a support structure operatively associated therewith;

FIGS. 11a and 11b are partial longitudinal cross-sectional views of a winged implant respectively illustrating variations of the cross-sectional configurations of the wing members of the implant bodies;

FIG. 12 is a top plan view of a ninth embodiment of a winged implant constructed in accordance with the principles and teachings of the present invention, wherein the wing member comprises a plurality of arcuately shaped wing members disposed within a circumferential array around the distal end portion of the implant body;

FIG. 13 is a partial, side, upwardly directed perspective view of the ninth embodiment winged implant illustrated within FIG. 12;

FIG. 14 is a partial, downwardly directed perspective view of the winged implant illustrated within FIGS. 12 and 13;

FIG. 15 is a plan perspective view of the winged implant illustrated within FIGS. 12-14;

FIG. 16 is a schematic view of a tenth embodiment of a winged implant constructed in accordance with the principles and teachings of the present invention wherein the wing member comprises a single continuous annular or circumferentially extending wing member which is effectively spirally oriented so as to effectively be a smooth continuous structure of the uppermost one of the external threads disposed upon the external peripheral surface of the implant body;

FIG. 17 is an eleventh embodiment of a winged implant constructed in accordance with the principles and teachings of the present invention wherein the wing member comprises a pair of discontinuous annular or circumferentially extending wing members which are effectively spirally oriented so as to effectively define smooth continuous structures of the uppermost one of the external threads disposed upon the external peripheral surface of the implant body;

FIG. 18 is a view similar to that of FIG. 13 showing, however, the tenth embodiment of the winged implant as illustrated within FIG. 16;

FIG. 19 is a view similar to that of FIG. 14 showing, however, the tenth embodiment of the winged implant as illustrated within FIG. 16; and

FIG. 20 is a view similar to that of FIG. 15 showing, however, the tenth embodiment of the winged implant as illustrated within FIG. 16.

### DETAILED DESCRIPTION OF THE ILLUSTRATED EMBODIMENTS

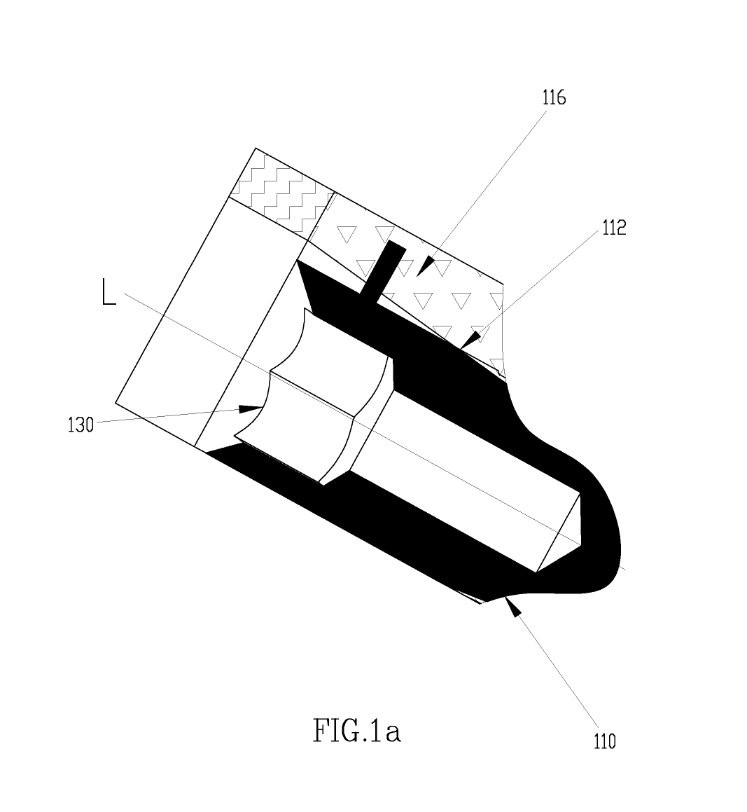

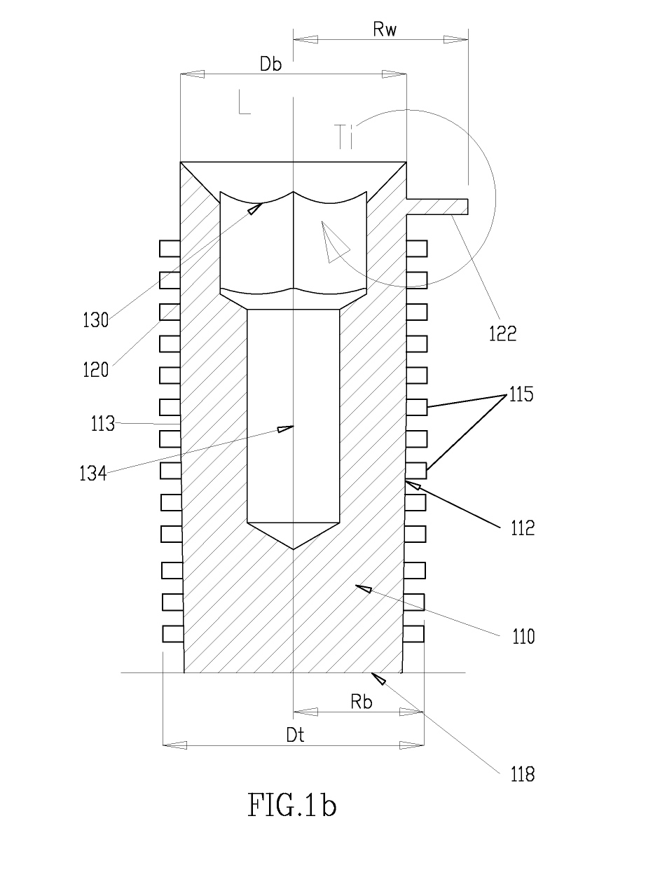

Reference is initially directed to FIG. 1a. FIG. 1a discloses a first embodiment of a winged implant 110 which is designed to be implanted into a substrate 116 wherein such substrates 116 may include, for example, bone or osseous tissues. With reference being additionally made to FIG. 1b, the winged implant 110 is seen to comprise an implant body 112 which has a generally cylindrical and/or frusto-conical configuration and which comprises a body core 113 having a predetermined external diameter Db. The implant body comprises an apical end 118 and a distal end 120, and a longitudinal axis L extends through the implant body 112 from the apical end 118 to the distal end 120. A screwing-in direction Ti is defined around the longitudinal axis L, and external threads 115 are disposed upon the external periphery of the implant body 112 such that the implant body 112 cuts into and effectively threadingly engages and embeds itself within the substrate 116 when the implant body 112 is inserted into the substrate 116 as a result of being rotated relative to the substrate 116. It is seen that the diametrical extent of the external threads 115, as measured at their crest portions, is denoted by Dt which is larger or greater than the diametrical extent Db of the implant body 112.

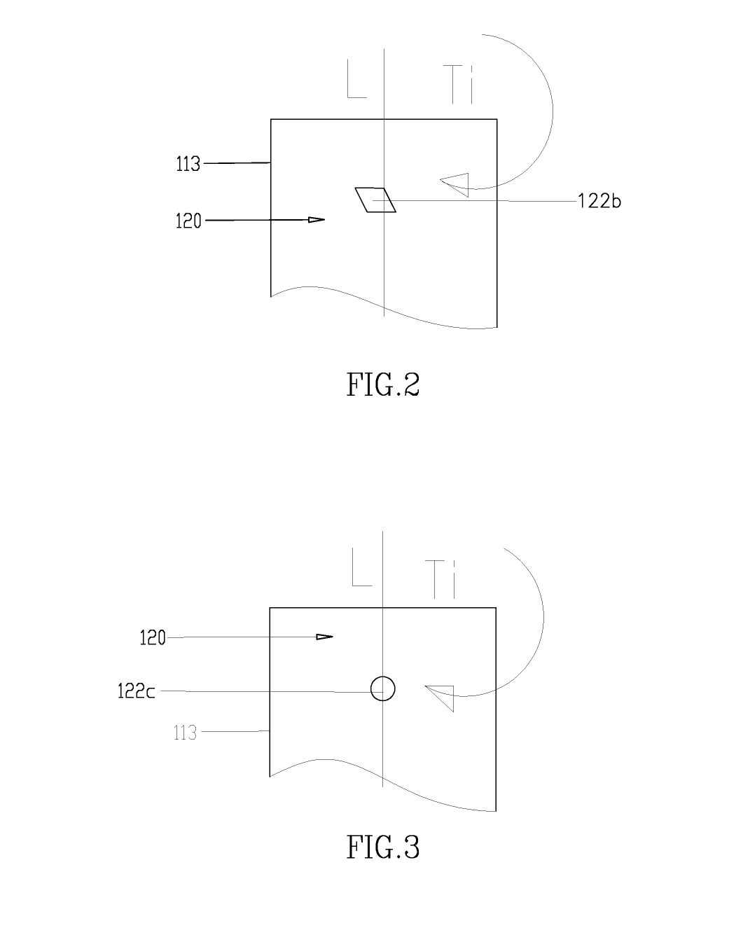

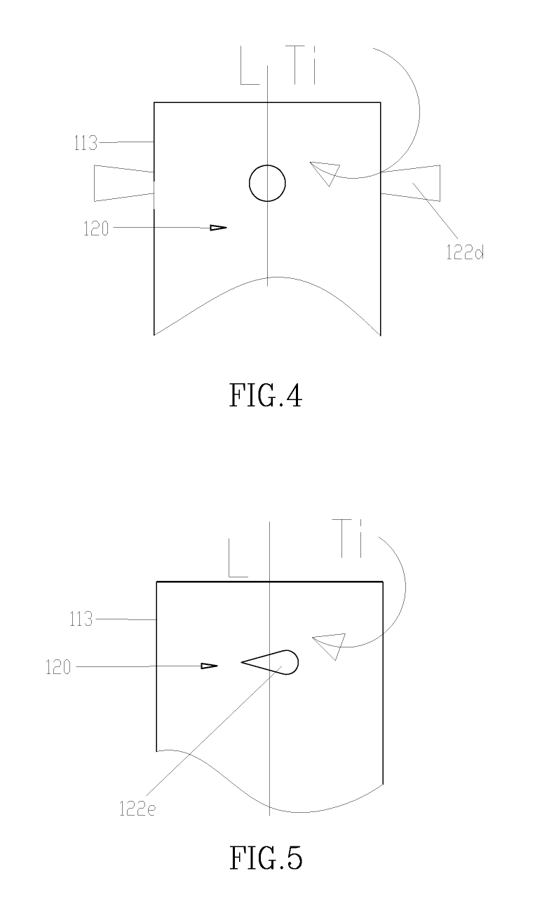

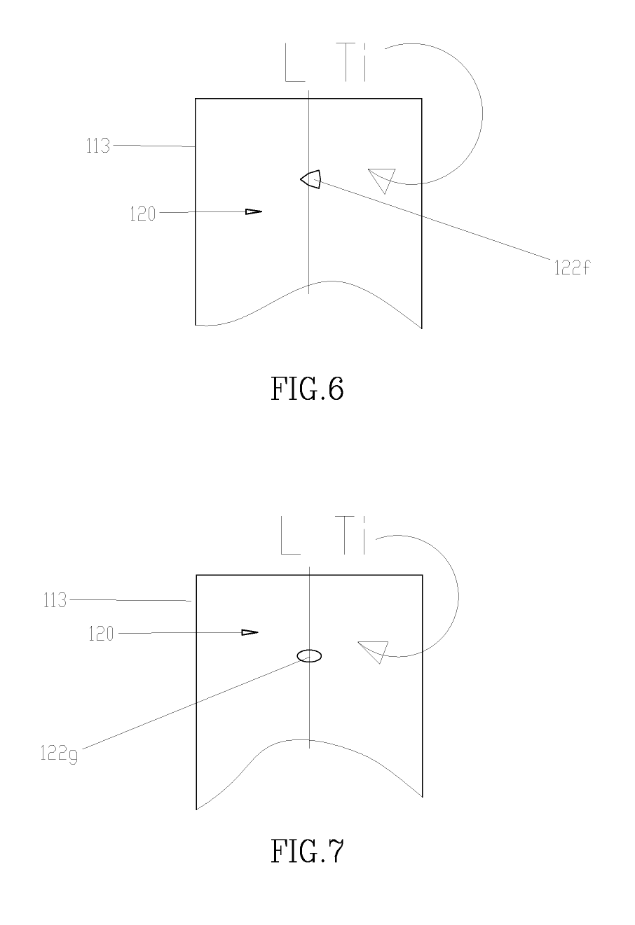

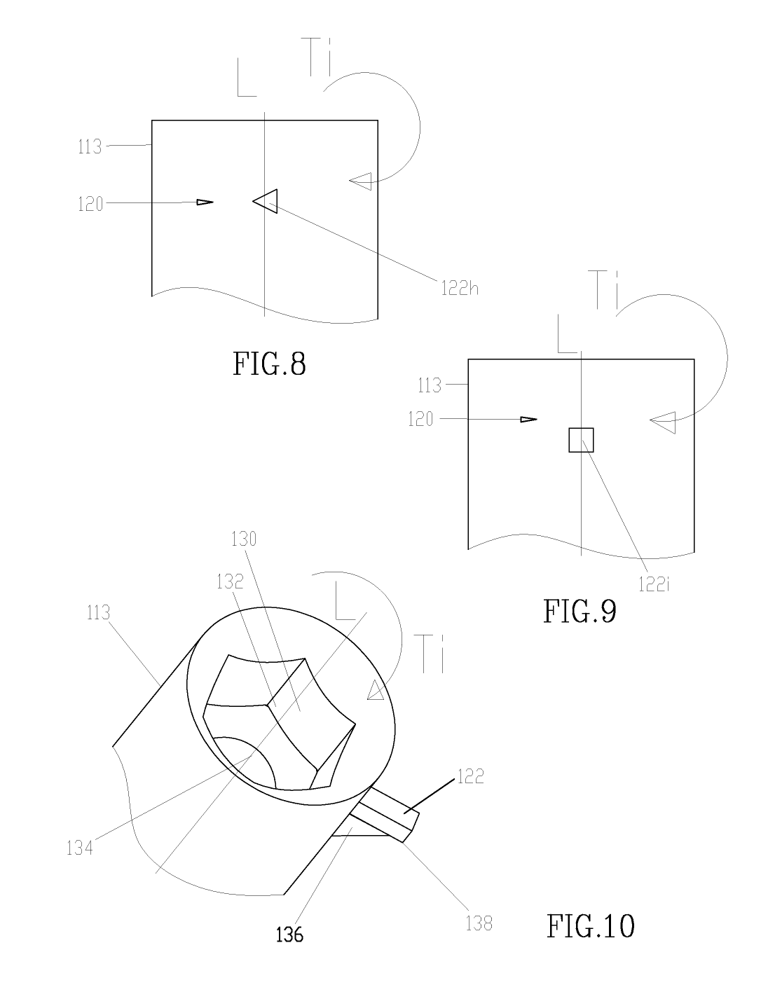

It is also seen that the distal end 120 of the winged implant body 112 has at least one wing member 122 which extends generally radially outwardly from the distal end 120 of the winged implant body 112. The at least one wing member 122 may have any desirable cross-sectional configuration 128, such as, for example, and for illustrative purposes only, as illustrated by means of the different embodiments illustrated within FIGS. 2 to 9, the exemplary wing members having cross-sections as shown, wherein similar components are denoted by similar reference numbers subsequently denoted by subscript letter following each exemplary cross-sectional wing component. More particularly, FIG. 2 schematically illustrates a wing member section 122_{b} having a rhomboid cross-sectional configuration, FIG. 3 schematically illustrates a wing member section 122, having a circular cross-sectional configuration, FIG. 4 schematically illustrates a wing member section 122_{d} having a frusto-conical cross-sectional configuration, FIG. 5 schematically illustrates a wing member section 122ₑ having a teardrop-shaped cross-sectional configuration, FIG. 6 schematically illustrates a wing member section 122_{f} having a trigon-shaped cross-sectional configuration, FIG. 7 schematically illustrates a wing member section 122_{g} having an ellipsoid cross-sectional configuration, FIG. 8 schematically illustrates a wing member section 122ₕ having a triangular cross-sectional configuration, and FIG. 9 schematically illustrates a wing member section 1282ᵢ having a square-shaped cross-sectional configuration.

As may be readily appreciated from FIGS. 1a, 1b, 10, 11a, 11b, 12, and 14, the winged implant body 112 may have a depression 130 extending axially inwardly from its distal end 120, wherein the depression 130 comprises a hex-shaped socket 132 for receiving a suitably shaped rotary tool. Additionally, the winged implant body 112 may be formed with an axially oriented threaded receptacle to 134 for receiving a threaded screw or bolt, not illustrated. FIG. 10 further illustrates that the at least one wing member 122 may further have a wing support 136 which extends radially inwardly from the radially outermost end 138 of the at least one wing member 122 so as to terminate upon the distal end 120 of the implant body 112.

Similarly, other possible embodiments of the winged implant 110 are further schematically illustrated within FIGS. 11 to 15. For example, FIG. 11a shows a longitudinal cross-section through the distal end 120 of the winged implant 110 wherein the wing cross-section 140 of the at least one wing member 122 is illustrated. The wing cross-section 140 is trapezoidal in shape having a wide wing root 124 wherein the wing member 122 tapers towards the narrower wing tip 126. The at least one wing member 122 has a diametrical or radial extent Rw that is substantially larger than the diametrical extent Db or radial extent Rb of the implant body 112, and as can readily be seen from FIG. 1b, the diametrical or radial extent Rw of the wing member 122 is also substantially larger than the diametrical or radial extent Dt of the external threads 115. More particularly, the diametrical or radial extent Rw of the wing member 122 is at least 20% larger than the diametrical or radial extent Rb of the implant body 112.

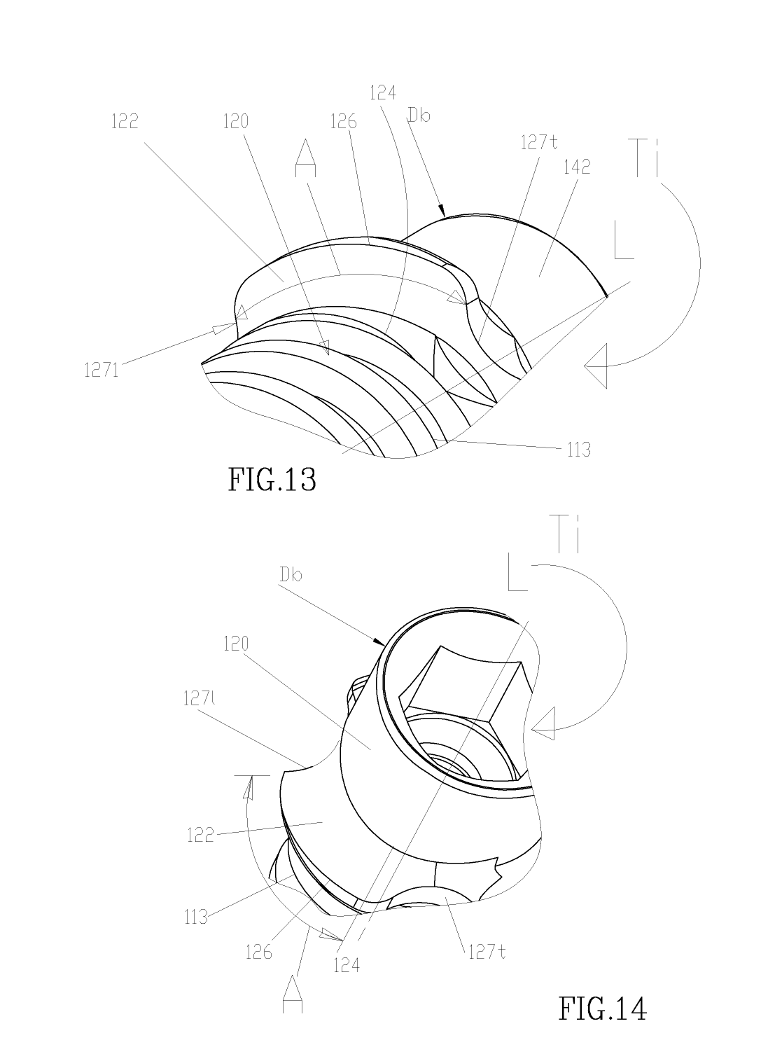

In addition, it is noted that the wing member 112 generally follows a spiral or helical path along the outer periphery 142 of the distal end 120 of the winged implant 110, as seen in FIG. 13, and is preferably smoothly integrated into the uppermost thread of the external threads 115. More particularly, as can be seen from FIG. 11b, the wing tip 126 of the at least one wing member 122 may be narrowed further so as to smoothly integrate into the external threads 115 and thereby facilitate the threading-in of the winged implant 110.

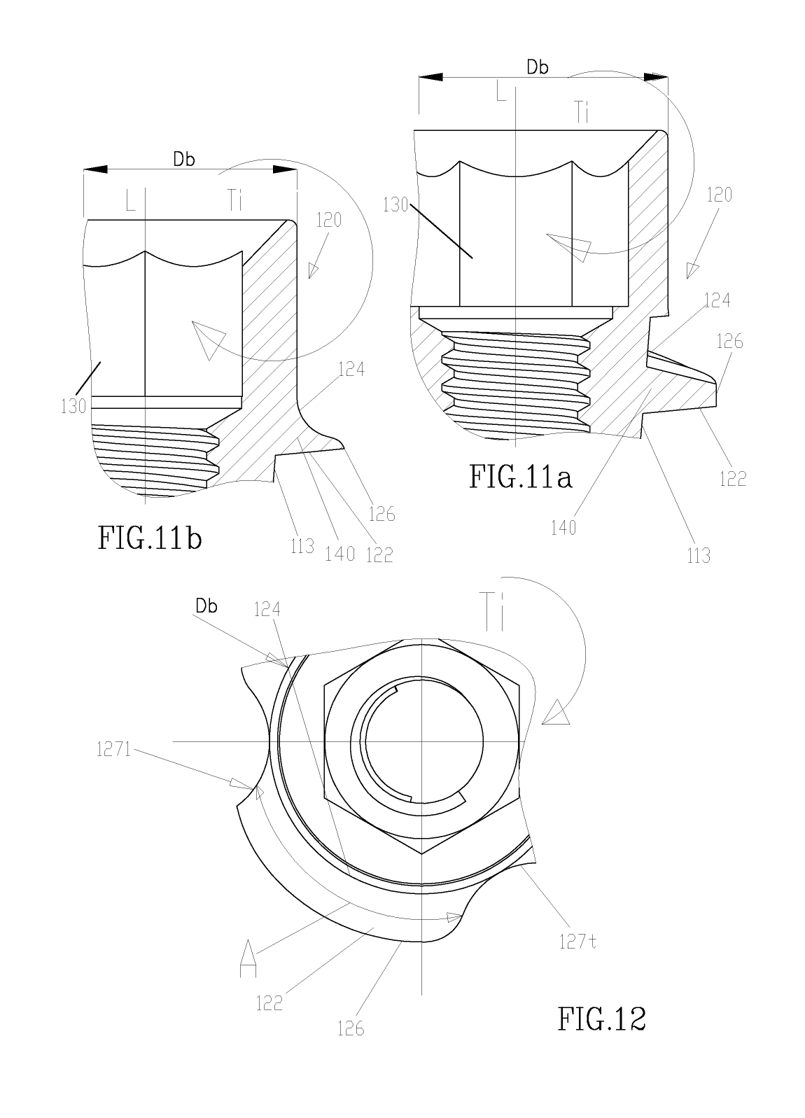

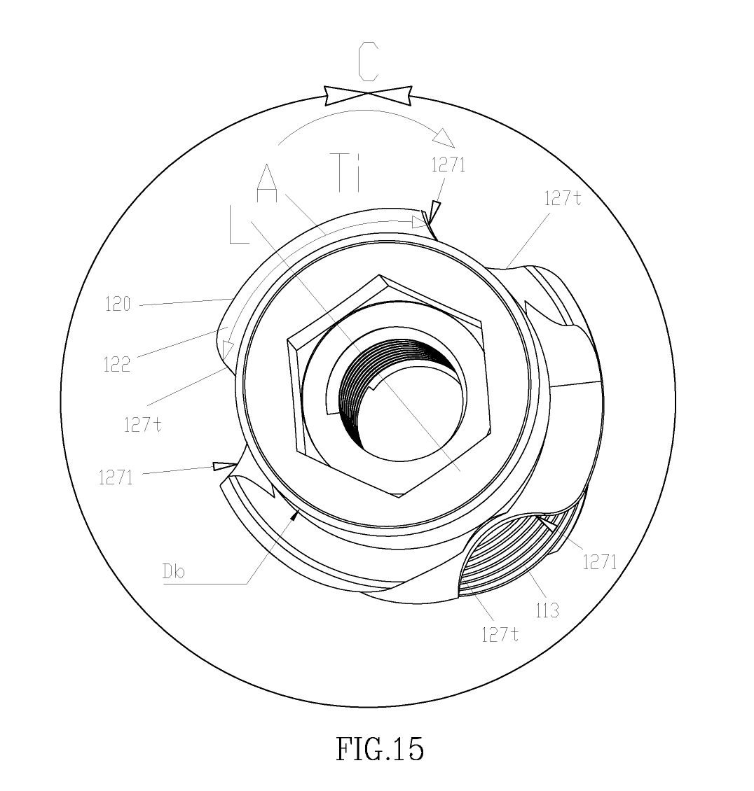

Continuing still further, the at least one wing member 122 extends generally transversely to the longitudinal axis L, projecting generally radially outwardly away from the distal end 120 of the implant body 112, from its wing root 124 where the at least one wing member 122 essentially merges with the implant body 112, to its distal wing end 126, and may arcuately or angularly extend peripherally from a leading end 127i to a trailing end 127t as can best be appreciated from FIGS. 12-15. The leading end 127i is disposed circumferentially forwardly along the threading-in direction Ti relative to the trailing end 127t. The at least one wing member 122 projects beyond the diametrical extent Db of the implant body 112 at the distal end 120 and may comprise discontinuous circumferential sections, each one of which spans an arcuate or angular extent A which extends peripherally along the circumferential extent C of the entire wing member 122, as can best be appreciated from FIG. 15, wherein each sectional extent A of each wing section forms only a fractional portion of the entire circumferential extent C of the entire wing member 122.

As can best be appreciated still further from FIG. 15, yet another exemplary embodiment of the wing implant 110 is illustrated wherein, for example, different sections of the at least one wing member 122 are disclosed as being located at different axial positions along, or with respect to the longitudinal axis L, and may also be staggered either circumferentially around the distal end 120 of the implant body 112. Still further, all of the wing sections may be disposed along a single helical or spiral locus.

During an implant procedure, an exemplary method of enhancing the stability of the winged implant 110 may be employed. According to such an exemplary method, the implant body 110 may be provided with the at least one wing member 122 extending generally away from the wing implant body 112 adjacent the distal end 120 thereof. When the winged implant 110 is implanted, for example within a crater which may be formed during implant procedure, the implant body 112 may be further supported by the at least one wing member 122, thereby enhancing the stability of the winged implant 110 within the crater of the substrate 116.

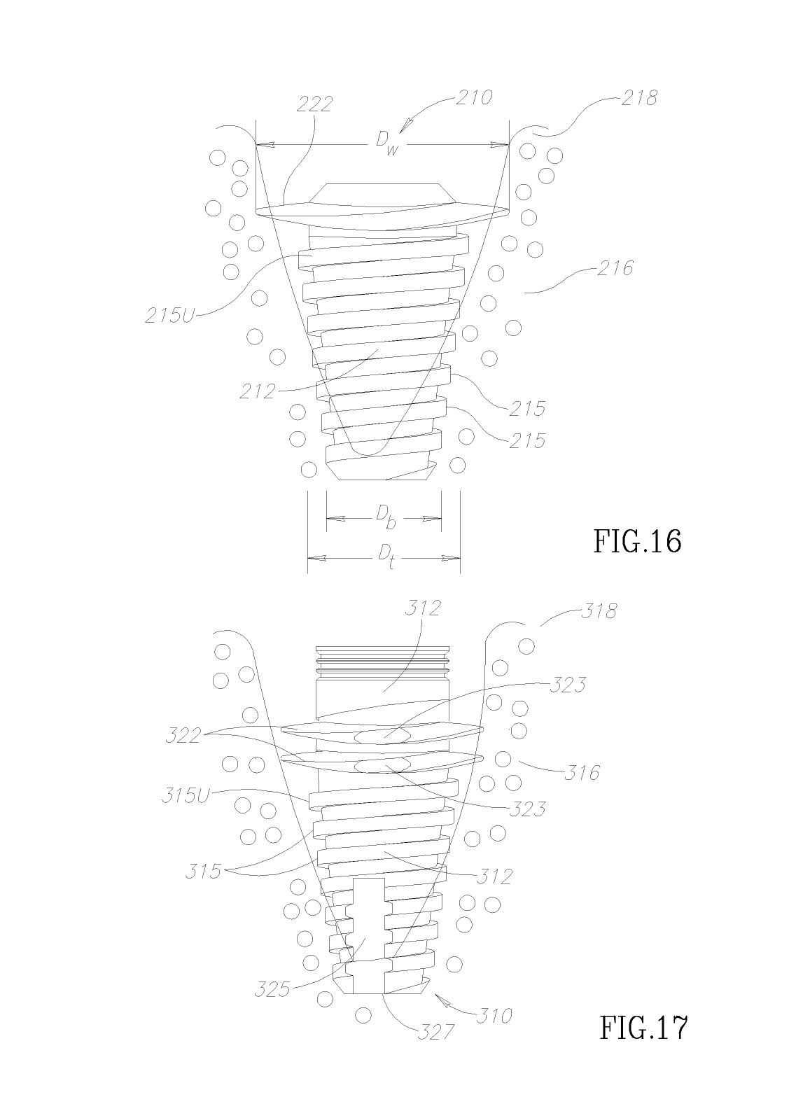

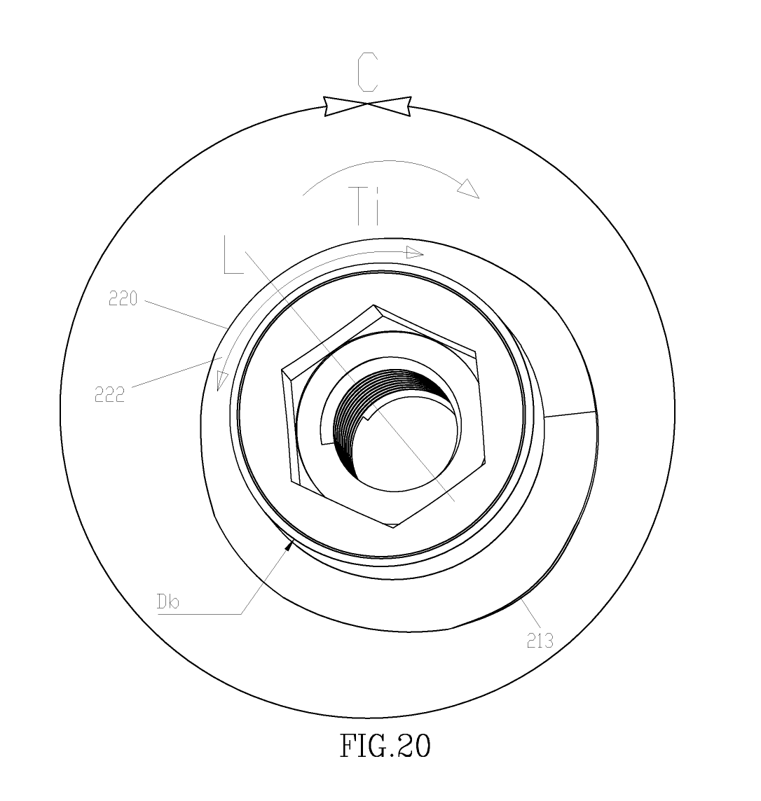

With reference now being made to FIGS. 16 and 18-20, a tenth embodiment of a new and improved implant is illustrated and is designated by the reference character 210. Component parts of the implant 210 which correspond to component parts of the implant 110 will be designated by corresponding reference characters except that they will be within the 200 series. As can be appreciated from FIG. 16, the implant 210 comprises an implant body 212 having external threads 215 disposed around the external peripheral surface of the implant body 212. In addition, the implant body 212 is also provided with a single, continuous annular wing member 222 which is structured so as to define a smooth continuation of the uppermost one of the external threads 215U. In this manner, when the implant 210 is rotated into the hole or crater of the patient's mouth or oral cavity into which the implant 210 is to be inserted, the external threads 215 of the implant 210 self-tap and threadingly engage and embed themselves within the bone 216 of the oral cavity. In addition, it will also be appreciated that the annular wing member 222 will like engage and embed it-self into the bone and/or osseous tissue portion 218 of the oral cavity so as to in fact stabilize the implant 210 within the implant site. As previously noted with respect to prior embodiments of the winged implant 110, the diametrical extent Dw of the wing member 222 is substantially larger than both the diametrical extents Db and Dt of the implant body 212 and 215, respectively, and in particular, the diametrical extent Dw of the wing member 222 is 20% larger than the diametrical extent Db of the implant body 212.

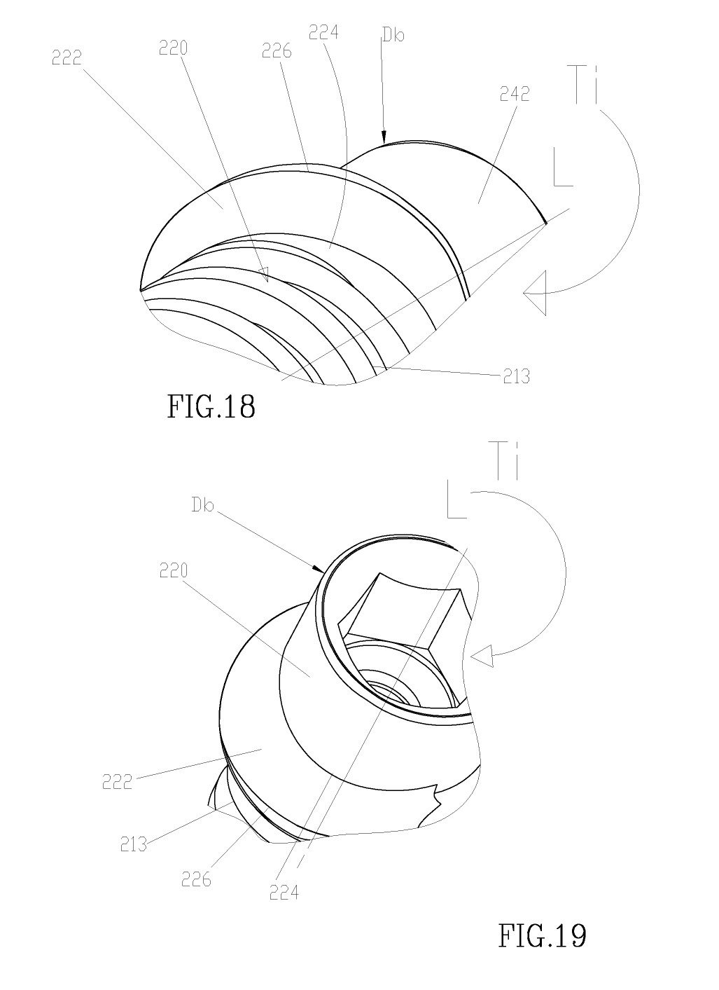

Lastly, with reference now being made to FIG. 17, an eleventh embodiment of a new and improved implant is illustrated and is designated by the reference character 310. Component parts of the implant 310 which correspond to component parts of the implants 110,210 will be designated by corresponding reference characters except that they will be within the 300 series. More particularly, it is seen that in accordance with the teachings of the eleventh embodiment implant 310, there is provided a pair of discontinuous annular wing members 322 wherein the discontinuities are disclosed at 323. In this manner, each wing member section can encompass a predetermined arcuate extent A as was disclosed within the previous embodiments of the wing members 112. A flute 325 is also provided upon the leading or apical end 327 of the implant 310 so as to facilitate initial cutting into the bone and/or osseous tissue.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A method for implanting an implant within osseous tissue or bone, and for enhancing the stability of said implant within the osseous tissue or bone, comprising the steps of:
providing an implant having a longitudinal axis L, an implant body defined around said longitudinal axis L so as to have a predetermined diametrical extent, a plurality of external threads formed around external side wall portions of said implant body, each of said plurality of threads having a predetermined diametrical extent as measured at its crest portions, and at least one wing member fixedly mounted upon an external peripheral side wall portion of said implant body and projecting radially outwardly from said external peripheral side wall portion of said implant body so as to have a diametrical extent which is substantially larger than said predetermined diametrical extent of said implant body and said predetermined diametrical extents of said plurality of external threads; and
rotating said implant body in a threading-in direction during an implant procedure such that said implant is implanted within the osseous tissue or bone as a result of said external threads of said implant body effectively cutting and defining female threads within the osseous tissue or bone, and wherein said at least one wing member of said implant body also cuts into the osseous tissue or bone so as to support said implant within the osseous tissue or bone, thereby enhancing the stability of said implant within the osseous tissue or bone.

2. The method as set forth in claim 1, further comprising the step of:
forming said at least one wing member so as to extend transversely to said longitudinal axis L of said implant and away from a wing root, adjacent to said implant body, to a wing tip, wherein said wing tip cuts into the osseous tissue or bone.

3. An implant for implantation within osseous tissue or bone, comprising:
an implant having a longitudinal axis L, an implant body defined around said longitudinal axis L so as to have a predetermined diametrical extent, a plurality of external threads formed around external side wall portions of said implant body, each one of said plurality of external threads having a predetermined diametrical extent as measured at their crest portions, and at least one wing member fixedly mounted upon an external peripheral side wall portion of said implant body, wherein said at least one wing projects radially outwardly from said external peripheral side wall portion of said implant body so as to have a diametrical extent which is substantially larger than said predetermined diametrical extent of said implant body and said predetermined diametrical extents of said plurality of threads, such that when said implant body is rotated in a threading-in direction during an implant procedure, said implant is implanted within osseous tissue or bone as a result of said external threads of said implant body effectively cutting into and defining female threads within the osseous tissue or bone and wherein said at least one wing of said implant body also cuts into the osseous tissue or bone so as to support said implant within the osseous tissue or bone thereby enhancing the stability of said implant within the osseous tissue or bone.

4. The implant as set forth in claim 3, wherein:
said at least one wing member is fixedly mounted upon a distal end portion of said implant body; and
said at least one wing member comprises a wing support extending from a tip portion of said at least one wing member and terminating at said distal end portion of said implant body.

5. The implant as set forth in claim 3, wherein:
said implant body has a socket portion formed within said distal end portion so as to accommodate a tool for imparting rotation to said implant.

6. The implant as set forth in claim 3, wherein:
said implant body is formed with a threaded receptacle for receiving a threaded screw or bolt.

7. The implant as set forth in claim 3, wherein:
said at least one wing member has a cross-sectional configuration comprising a trapezoid having a relatively wide wing root and a relatively narrow wing tip.

8. The implant as set forth in claim 3, wherein:
said implant body has a circumferential extent C; and
said at least one wing member has an arcuate extent A, wherein said arcuate extent A of said at least one wing member is less than said circumferential extent C of said implant body.

9. The implant as set forth in claim 3, wherein:
said at least one wing member comprises a plurality of wing sections.

10. The implant as set forth in claim 9, wherein:
each one of said plurality of wing sections is located at a different axial position as measured longitudinally away from said distal end portion of said implant body.

11. The implant as set forth in claim 10, wherein:
each one of said plurality of wing sections is staggered circumferentially about said distal end portion of said implant body with respect to other ones of said plurality of wing sections.

12. The implant as set forth in claim 11, wherein:
each one of said plurality of wings is staggered axially relative to said distal end portion of said implant body.

13. The implant as set forth in claim 11, wherein:
said plurality of circumferentially staggered wings are disposed upon a single helical locus.

14. The method as set forth in claim 1, further comprising the step of:
fixedly mounting said at least one wing member upon a distal end portion of said implant body.

15. The method as set forth in claim 14, further comprising the step of:
providing said implant body with a socket portion within said distal end portion of said implant body so as to accommodate a tool for imparting rotation to said implant.

16. The method as set forth in claim 1, further comprising the step of:
providing said implant body with a threaded receptacle for receiving a threaded screw or bolt.

17. The method as set forth in claim 16, further comprising the step of:
providing said implant body with a plurality of wing members.

18. The method as set forth in claim 17, further comprising the step of:
mounting said plurality of wing members upon said implant body such that said plurality of wing members are located at different axial positions upon said implant body as measured longitudinally away from said distal end portion of said implant body.

19. The method as set forth in claim 17, further comprising the step of:
mounting said plurality of wings upon said implant body such that each one of said plurality of wings is staggered circumferentially about said distal end portion of said implant body with respect to other ones of said plurality of wings.

20. The method as set forth in claim 19, further comprising the step of:
mounting said plurality of wing upon said implant body such that said plurality of circumferentially staggered wings are disposed upon a single helical locus.
